(19) United States
(12) Patent Application Publication
(10) Pub. No.: US 2002/0055927 A1
(43) Pub. Date: May 9, 2002

(54) DYNAMIC DISPLAY SYSTEM

(76) Inventors: MARK CALEM, FALLS CHURCH, VA (US); BEN OWEN, AUSTIN, TX (US); GREGORY YAPCZENSKI, COLONIA, NJ (US)

Correspondence Address: STAAS & HALSEY, 700 ELEVENTH STREET, N.W., WASHINGTON, DC, 20001

(21) Appl. No.: 09/223,561

(22) Filed: Dec. 31, 1998

(51) Int. Cl. G06F 17/00

(52) U.S. Cl. 707/102

(57) ABSTRACT

A dynamic display system for a state-wide human services organization that produces a custom display for each county in the state. The system includes a database having a record of each possible display routine for each window for each county and an indication as to whether each display routine is active for each county. A display procedure identifies a county of a user, dynamically accesses the records for the identified county, displays an indication of each active display routine, and creates a display in which a selected one of the possible display routines is executed. The system is especially relevant to human services organizations in states where individual counties have recently been placed in control of administering the various programs. The system allows the state to purchase a single system and easily configure the different counties using a centralized database to avoid repetitive costs associated with individual installations.

### BACKGROUND OF THE INVENTION

1. Field of the Invention

The present invention is directed to a system including apparatus, software and methods for providing an organization with a single display engine that allows customization of displays for various group within an organization while maintaining a common data structure.

2. Description of the Related Art

Human services programs in the United States have long been operated under the control of the Federal Government. However, recent legislation has increasingly placed the burden of administering these programs on the various states. Many states have given control over to their individual counties. In these states, the county human service administrations access central databases, in many cases statewide databases, storing information about the clients of the various human services programs. These databases are typically implemented with state funding.

Case workers in these county controlled systems must use legacy programs provided by the state to manage their data. These programs are typically legacy systems set up for the old Federally controlled programs. Such legacy systems inevitably require workers to access screens and manipulate data that is not required for their particular programs. In other words the old Federally controlled programs required a large amount of information for each client, much of which is inapplicable to any particular client in any particular county system. Should county requirements dictate the use of data not managed by the legacy system operating on federally mandated data, the counties must create their own programs with their own interfaces or track such data manually.

Another problem the caseworker has to face is that of multiple interfaces. Currently, each separate human services program requires the use of a different system having a unique interface. Many of these systems have a command line interface.

Total migration to new systems is not economically feasible in many instances. The costs to replicate the functionality provided by the legacy systems would be enormous. Further, the costs of transferring the data, painstakingly accumulated over many years, would be prohibitive.

To control costs, state governments need a program that allows flexible implementation using a single dynamic interface to legacy systems (or new systems). Such a system needs to be simple enough to implement with a minimum of training. To answer the needs of both the state and county, a system is required that allows each county to customize the data entry and display screens while accessing centralized data structures. Such a system would find use outside of the human services field and would be useful in any compartmentalized organization requiring a flexible interface customizable for the various business units or groups.

### SUMMARY OF THE INVENTION

It is an object of the present invention to provide a single dynamic display system capable of creating individualized displays for various groups within an organization.

It is yet another object of the present invention to provide users with a customized display of records based on their group within an organization.

It is yet another object of the present invention to provide a standardized interface for accessing and modifying human services records as they exist on various non-homogeneous systems for county controlled human services programs.

The above objects can be obtained by dynamic display system for producing a custom display for each of a plurality of groups in an organization including: a database having a record of each possible display routine for each window for each group and an indication as to whether each display routine is selected for display for each group; and a display procedure that identifies a group of a user, dynamically accesses the records for the identified group, displays an indication of each display routine selected for display, and creates a display in which one of the display routines selected for display is executed.

The above objects can also be achieved in a dynamic display system for displaying dynamic lists wherein elements on a list vary based upon a group in an organization, the system including: a centralized database storing, for each dynamic list utilized by each group, all possible elements in the list and an indication for each element of whether the element is active; and wherein the display procedure provides a service to a display routine of retrieving all of the elements of a displayed pick list.

The above objects can also be achieved in a method of dynamically displaying an individualized screen based on a group in an organization to which a user belongs, the method including: storing, in a database, for each group an indication of all of the possible display routines along with an indication of whether each possible display routine is active for that group; identifying a group to which a user belongs; accessing the database to retrieve an indication of each active display routine for the group to which the user belongs; displaying an indication of each active display routine; creating a sub-section for a selected active display routine; and running the selected active display routine and outputting the display of the selected active display routine in the sub-section.

The above objects may also be achieved in a dynamic display system for a state-wide human services organization that produces a custom display for each county in the state, the system including: a database having a record of each possible display routine for each window for each county and an indication as to whether each display routine is active for each county; and a display procedure that identifies a county of a user, dynamically accesses the records for the identified county, displays an indication of each active display routine, and creates a display in which a selected one of the possible display routines is executed.

The above objects can also be achieved in a computer readable medium encoded with software for dynamically displaying an individualized screen based on a group in an organization to which a user belongs by performing the procedures of: storing, in a database, for each group in an organization an indication of all of possible display routines along with an indication of whether each possible display routine is active for that group; identifying a group to which a user belongs; accessing the database to retrieve an indication of each active display routine for the group to which the user belongs; displaying an indication of each active display routine; creating a sub-section for a selected active display routine; and running the selected active display routine and outputting the display of the selected active display routine in the sub-section.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is an example of a configuration screen for the dynamic display system in accordance with a preferred embodiment of the present invention.

FIGS. 2A and 2B are examples of screens produced by the dynamic display system in accordance with the preferred embodiment of the present invention.

FIG. 3 is a block diagram of a system embodying the dynamic display system in accordance with the preferred embodiment of the present invention.

FIG. 4 is a flow chart of the Dynamic Display procedure used by the dynamic display system in accordance with the preferred embodiment of the present invention.

FIG. 5 is a data flow diagram of the dynamic tab creation process.

FIG. 6 is a data flow diagram of the dynamic drop-down list creation process.

FIG. 7 is an example of a screen produced by the dynamic display system with a pick list.

### DESCRIPTION OF THE PREFERRED EMBODIMENTS

Reference will now be made in detail to the preferred embodiment of the present invention, examples of which are illustrated in the accompanying drawings, wherein like reference numerals refer to like elements throughout.

The detailed description which follows is presented in terms of general procedures and symbolic representations of operations of data bits within a computer memory, associated computer processors, networks, and network devices. These procedure descriptions and representations are the means used by those skilled in the data processing art to most effectively convey the substance of their work to others skilled in the art. A procedure is here, and generally, conceived to be a self-consistent sequence of steps or actions leading to a desired result. Thus, the term “procedure” is generally used to refer to a series of operations performed by a processor, be it a central processing unit of a computer, or a processing unit of a network device, and as such, encompasses such terms of art as “objects,” “functions,” “subroutines” and “programs.”

In general, the sequence of steps in the procedures require physical manipulation of physical quantities. Usually, though not necessarily, these quantities take the form of electrical or magnetic signals capable of being stored, transferred, combined, compared or otherwise manipulated. Those of ordinary skill in the art conveniently refer to these signals as “bits,” “values,” “elements,” “symbols,” “characters,” “images,” “terms,” “numbers,” or the like. It should be recognized that these and similar terms are to be associated with the appropriate physical quantities and are merely convenient labels applied to these quantities.

In the present case, the procedures are machine operations performed in conjunction with other machines and possibly human operators. Useful machines for performing the operations of the present invention include general purpose digital computers, routers, switches, and other similar devices. In general, the present invention relates to method steps, software, and associated hardware configured to process electrical or other physical signals to generate other desired physical signals.

The apparatus set forth in the present application may be specifically constructed for the required purposes or it may comprise a general purpose computer or terminal selectively activated or reconfigured by a computer program stored in the computer. The procedures presented herein are not inherently related to any particular computer or other apparatus. In particular, various general purpose machines may be used with programs in accordance with the teachings herein, or it may prove more convenient to construct more specialized apparatus to perform the required method steps. The present invention is particularly relevant to a Windows environment such as those produced by Microsoft®, including WINDOWS 98® and WINDOWS NT®. The present invention is also particularly relevant to use on the World Wide Web via implementation with a variety of existing tools, including HTML and JAVA®.

However, one of ordinary skill in the art will recognize that there exists a variety of platforms and languages for creating software for performing the procedures outlined herein. One of ordinary skill in the art also recognizes that the choice of the exact platform and language is often dictated by the specifics of the actual system constructed, such that what may work for one type of general purpose computer may not be efficient on another type of general purpose computer. In practice, the present invention can be realized utilizing Powersoft's POWERBUILDER® tool.

One of ordinary skill in the art to which this invention belongs will have a solid understanding of the database structures and the ability to program general database systems. It being recognized that such practitioners do not require specific details of the software, but rather find data structure descriptions and process descriptions more desirable (due to the variety of suitable hardware and software platforms), such specifics are not discussed to avoid obscuring the invention.

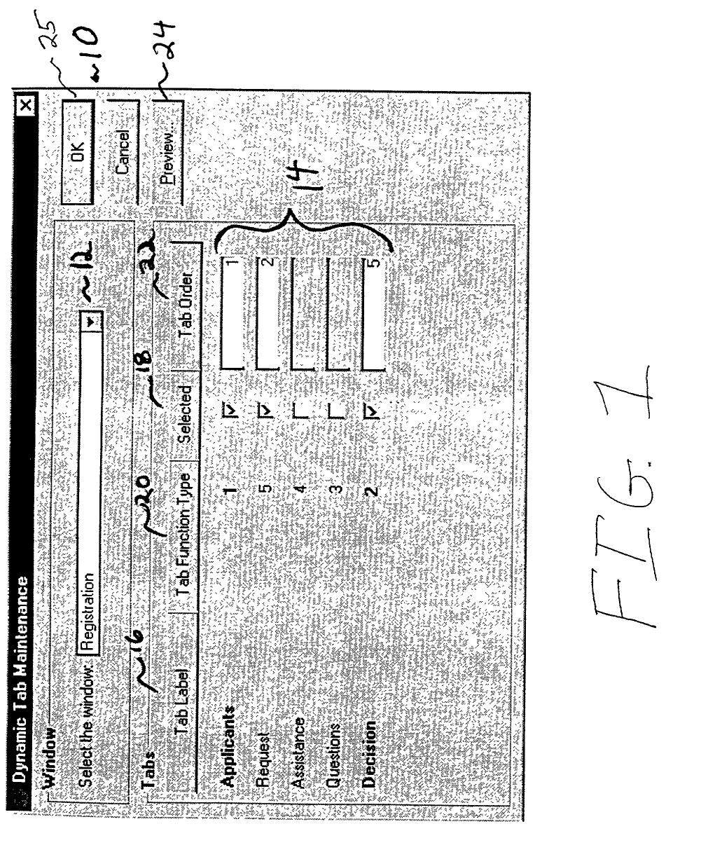

FIG. 1 is an example of a set-up screen for the dynamic display system in accordance with a preferred embodiment of the present invention. The Dynamic Tab Maintenance screen 10 is presented to the personal in charge of installing/maintaining the dynamic display system as set forth in the present invention. While, the Dynamic Tab Maintenance screen 10 may be constructed in any applicable programming environment using a graphical user interface, the present inventors have had particular success in utilizing the POWERBUILDER® product in a WINDOWS® environment.

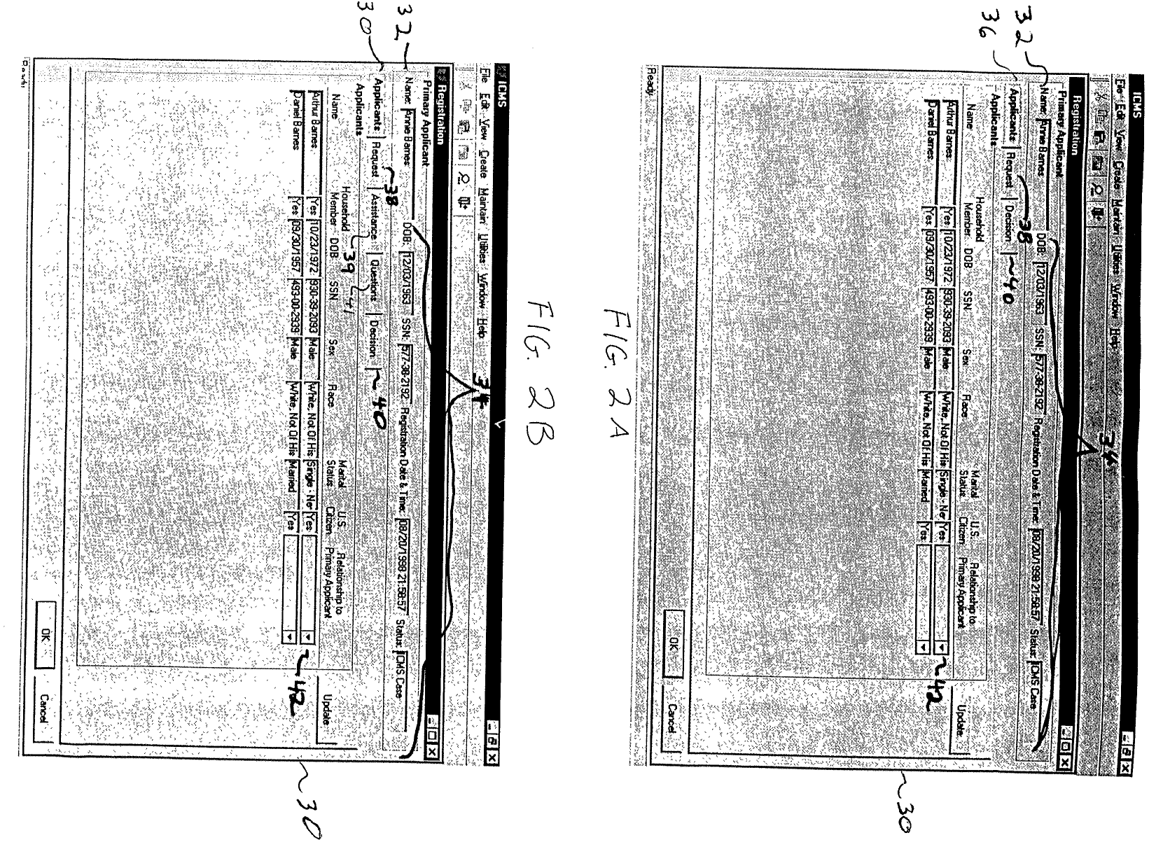

The dynamic display system will construct a personalized screen based on the input received from the Dynamic Tab Maintenance screen 10. FIG. 2A is an example of a screen produced by the dynamic display system, using the information set forth in FIG. 1.

Referring once again to FIG. 1, the Dynamic Tab Maintenance screen 10 allows the installer/manager to select a window to build from a pick list, which may be displayed using a pull down box 12. The term “pick list” is used to generally describe a list of options or choices presented to a user to the purpose of selecting one or more of the options or choices. There exists a variety of mechanisms for implementing pick lists such as: drop down boxes, list boxes, radio buttons and check boxes. In the example shown in FIG. 1 a Registration window is being constructed. The dynamic display system retrieves a list of possible “Tabs” for the registration window. The “Tab” metaphor is used as an illustrative example of an applicable graphical user interface organization metaphor, those of ordinary skill in the art will recognize that other organization metaphors are possible, such as screen associated with icons. The registration window is built by supplying values in a table 14.

In the example shown in FIG. 1, five possible tab pages are listed in a Tab Label column 16 of the table 14: Applicants; Request; Assistance; Questions; and Decision. Each of these Tab Labels references a pre-constructed tab division, or “tab page”. The installer/manager basically selects which tabs to display in the selected column 18 by, for example, entering a “Y” or a “N” or using a standard check box as shown.

Some of the tabs may be required and are marked as such. In the example shown in FIG. 1, the Applicants and Decision tabs are bolded and the check mark in the selected column is indelibly filled in. These may be related to state-wide requirements that the counties (or other sub-organization) must implement.

It is anticipated that groups in a human services organization will be able to reuse many of the tab definitions. Generally, tabs are divided into types as shown in the Tab Function Type column 20. A rule can be implemented that only one tab of each type may be displayed. Thus, if the particular group needs a different Request Tab page, the designer can create a Request 2 Tab page with an assigned type of 5. During selection, only one of “Request” or “Request 2” may be selected, as only one display of type “5” may be used

After selecting which tabs to display in a window, the installer/manager selects a sort order in the Tab Order Column 22 by, for example, setting a numerical order of precedence. This will control the order that tab indications are displayed on the window during display. An optional data point is an alternative display name for each tab. An input column for this optional feature is not shown to avoid obscuring the invention. Finally, the installer/manager may see a preview of the created window by activating the preview button 24.

Once the installer/manager is satisfied with his or her choices, he or she clicks the OK button 25 and the data is saved into a display definitions database as described hereinafter. When a user accesses the dynamic display system, a program residing on their local machine (or on a remote server) reads the database and dynamically creates a display based on the information created by the installer/manager during the set-up process.

Referring once again to FIG. 2A, a Registration window 30 is shown as created by the dynamic display system based on the information shown in the Dynamic Tab Maintenance window 10 in FIG. 1. The Registration window 30 has two main sections: a section listing the primary applicant using a Name text box 32 along with various information fields 34; and a Tab display section. The dynamic display system has created three tabs: an Applicant tab 36, a Request tab 38; and a Decision tab 40 displayed according to the sort order. As set forth above, the display associated with each tab is preset, such that different displays are achieved by selecting alternative tabs within a single tab type during installation/maintenance. Generally the tab process consist of several routines: data retrieval, data display, and data storage/modification. The data retrieval and storage routines must be programmed based upon the configurations of the base system from which the data is being accessed. The data display routine provides each tab screen with a variety of display/input devices related to the subject matter of the tab display.

In the example shown in FIG. 2A, a single pull down box 42 is shown associated with the entry field: Relationship to Primary Applicant. The data structure of the dynamic display device is particularly suited to assisting in the dynamic display of elements in such a pick list customized to the group or county of the user of the dynamic display screen. In this case, the user can, for example select from one of: “Applicant;” “Husband;” “Wife;” “Child;” etc . . . As one of ordinary skill in the art will recognize, there are a variety of ways in which pick lists can be displayed, the pull down list being shown as an example. Recognizing that many legacy systems are command line oriented, the dynamic display system provides apparatus, software and methods for dynamically filling in values on pick lists.

FIG. 2B shows an alternative registration window 30 created by additionally selecting the Assistance and Questions tabs for display in the Dynamic Tab Maintenance window 10. This adds the Assistance tab 39 and the Questions tab 41 to the Registration Window 30. The ease of changing the widow configuration enables the system to be used by a wide variety of personnel.

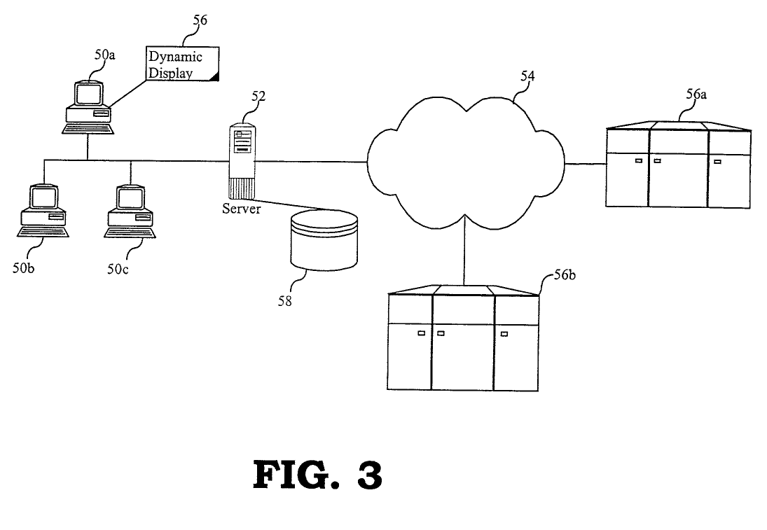

FIG. 3 is a block diagram of a system embodying the dynamic display system in accordance with the preferred embodiment of the present invention. A plurality of user terminals 50 (terminals 50a, 50b, 50c are shown as examples) are typically connected to a local server 52 which may act as a gateway to a network 54, such as a WAN or the INTERNET. The network 54 is in turn connected to at least one data repository 56 (two data repositories 56a and 56b being shown as an example). The data repositories 56 may be legacy database systems or newly added systems. The database containing the display definitions database may reside in a database 58 attached to the local server or on one of the data repositories 56.

The user terminal executes a Dynamic Display procedure 56, either stored locally or remotely, depending on the exact hardware configuration.

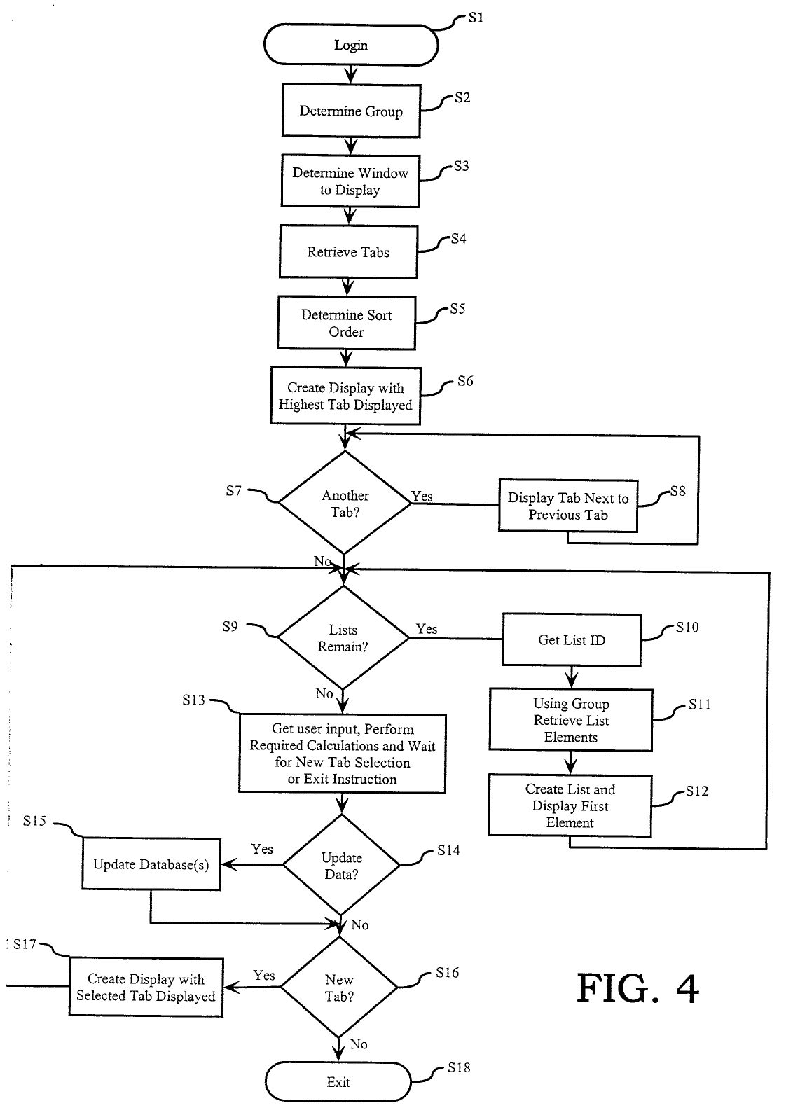

FIG. 4 is a flow chart of the Dynamic Display procedure 56 used by the dynamic display system in accordance with the preferred embodiment of the present invention. The process starts at step S1 with a login procedure. The login procedure obtains an indication of a group to which the user belongs. This group is identified in step S2. In the present example, the group is the County of the case worker.

Next in step S3, the dynamic display procedure next determines which window is to be displayed. This can be selected automatically or manually by the user. Thereafter, in step S4, the dynamic display procedure retrieves the tab definitions for the group, i.e. county, of the user. As set forth above, the tab definitions are set up by an installer/manager of the dynamic display system. The tab definitions may be stored in a table similar to Table 1:

TABLE 1
Dynamic Tab Table

| Field Name | Datatype | Comment | PK? | FK? |
|---|---|---|---|---|
| ID_CNTY | INTEGER | The county the tab definitions are | Yes | |
| | | for. | | |
| ID_RSRC | INTEGER | Resource id. A resource is a | No | Yes |
| | | Powerbuilder user interface window. | | |
| ID_TAB₁₃RSRC | INTEGER | The tab the definition is for, must be | | Yes |
| | | valid tab on tab₁₃rsrc | | |
| CD_SORT | SMALLINT | Where the tab appears from left to | No | No |
| | | right ordinal position in the window | | |
| FL_ACTV | CHAR | Y/N flag indicating whether tab | | |
| | | definition is selected. If Y, the tab is | | |
| | | displayed for all county workers | | |
| | | associated with id_cnty. If 'n' the tab | | |
| | | is not displayed for the county | | |
| | | workers associated with the id_cnty. | | |
| ID_CR | INTEGER | The ID of the worker whose action | | |
| | | caused the row to be added to the | | |
| | | table. | | |
| TS_CR | TIMESTAMP | The timestamp when the row was | | |
| | | added to the table. | | |
| ID_UP | INTEGER | The ID of the worker whose action | | |
| | | caused the table row to be updated | | |
| | | most recently. | | |
| TS_UP | TIMESTAMP | The timestamp when the table row | | |
| | | was most recently updated. | | |

For each county a record of each possible Tab is stored, with a indication in the FL_ACTV field as to whether the Tab is active. Table 1 shows several optional fields (ID_CR; TS_CR; ID_UP; and TS_UP) which may be utilized for a variety of functions, including security and housekeeping functions. They are presented here (along with similar entries in subsequent tables) to indicate to one of ordinary skill in the art additional data structures that may be useful in certain circumstances. Table 1 refers to a ID_TAB_RSRC referencing an entry, describing the properties of the Tab being referenced, in a Table 2, as follows:

TABLE 2
Tab Resource Table

| Field Name | Datatype | Comment | PK? | FK? |
|---|---|---|---|---|
| ID_TAB_RSRC | INTEGER | A unique identifier | Yes | |
| | | for a particular tab. | | |
| ID_RSRC | INTEGER | Resource id. A | | |
| | | resource is a | | |
| | | Powerbuilder user | | |
| | | interface window. | | |
| CD_TAB_TYPE | INTEGER | Type of the tab | No | |
| TX_OBJ_NAME | CHAR(40) | Powerbuilder object | | |
| | | name | | |
| TX_TAB_LABEL | | Weather the tab is | | |
| | | required | | |
| FL_RQRD | CHAR | | | |
| ID_CR | INTEGER | The ID of the | | |
| | | worker whose action | | |
| | | caused the row to be | | |
| | | added to the table. | | |
| TS_CR | TIMESTAMP | | | |
| ID_UP | INTEGER | The ID of the | | |
| | | worker whose action | | |
| | | caused the table row | | |
| | | to be updated most | | |
| | | recently. | | |
| TS_UP | TIMESTAMP | The timestamp | | |
| | | when the table row | | |
| | | was most recently | | |
| | | updated. | | |

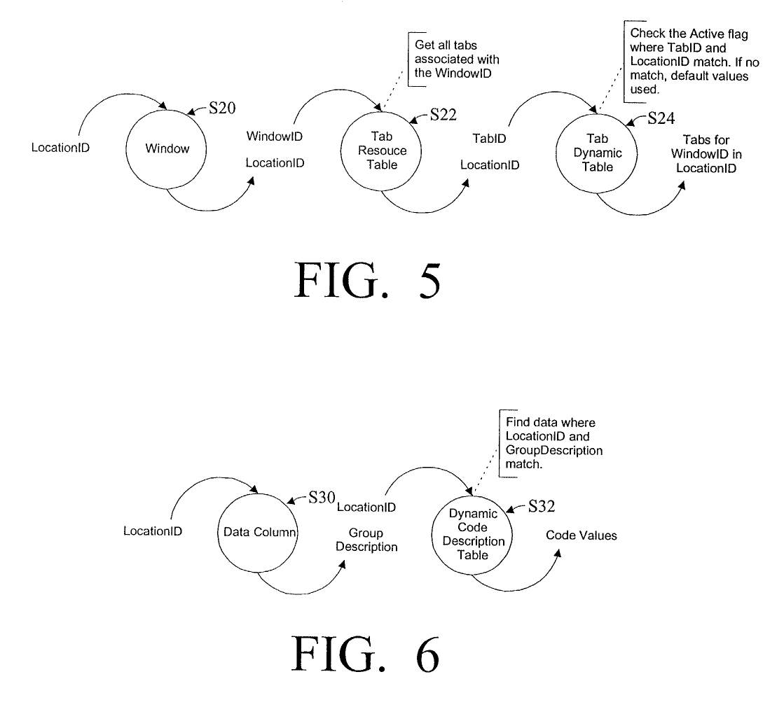

FIG. 5 is a data flow diagram of the dynamic tab identification process. Generally, when a window that has Dynamic Tab opens, a process that retrieves the list of tabs to be displayed using a current location identifier and a window's internal identifier. Thus, a window process in S20 receives a LocationID and passes the LocationID, along with a WindowID to the Tab Resource Table (see Table 2 above) in S22. Each possible tab type for the WindowID is retrieved. Thereafter, in S24 the Tab entries in the Dynamic Tab Table (see Table 1) are retrieved and checked to determine which Tabs are selected. If no Tabs are selected, a default display can be used. Referring once again to FIG. 4, once the tabs to be displayed have been retrieved in step S4, the sort order of the tabs is analyzed in step S5 and the display of the first, or highest, tab is performed in step S6. Preferably, the actual display of the contents of the tab is an individualized routine for each tab. In this example, the creation of other tabs and the filling in of list will be discussed, but one of ordinary skill in the art will recognize that any applicable process can be performed as part of the display. In the context of the preferred operating environment, such processes can include the calculation of display values, such as total benefits, the display of information from one of the data repositories 56, and any other required process.

After the initial creation of the first tab display in step S6 a determination is made in step S7 whether more tab indications need to be displayed. If more tab indications remain to be displayed the procedure goes to step S8 and the next tab indication is displayed next to the prior tab indication. Once all tab indications have been displayed the procedure goes to step S9.

As set forth above, the principals of the present invention are extremely useful in conjunction with pick lists. Accordingly, in step S9 a determination of whether any pick lists remains to be displayed and filled in. If any lists remain to be displayed the procedure goes to step S10 and the ID of the list is obtained. Next in step S11, using the County ID, a table is referenced to retrieve the elements in the list. Such a table is constructed by the installer/manager and may take the form of Table 3:

TABLE 3
Dynamic Code Table

| Field Name | Datatype | Comment | PK | FK |
|---|---|---|---|---|
| ID_CD | INTEGER | Unique integer code | Yes | No |
| | | by which the | | |
| | | information associated | | |
| | | with code is | | |
| | | referenced. | | |
| ID_CNTY | SMALL INT. | County ID code | Yes | |
| | | identifying a | | |
| | | specific county. | | |
| ID_GRP | CHAR(8) | Pneumonic group | Yes | |
| | | identifier used to | | |
| | | group values for | | |
| | | presentation in a list | | |
| | | box. | | |
| CD_ACTIVE | CHAR | Code indicating | | |
| | | whether the | | |
| | | code is active or not. | | |
| ID_CR | INTEGER | The ID of the worker | | |
| | | whose action caused | | |
| | | the row to be | | |
| | | added to the table. | | |
| TS_CR | TIMESTAMP | The timestamp | | |
| | | when the row was | | |
| | | added to the table. | | |
| ID_UP | INTEGER | The ID of the worker | | |
| | | whose action caused | | |
| | | the table row to be | | |
| | | updated most recently. | | |
| TS_UP | TIMESTAMP | The timestamp when | | |
| | | the table row was most | | |
| | | recently updated. | | |
| CD_SORT_SEQ | SMALLINT | sort sequence of the | | |
| | | ID_CD within | | |
| | | ID_GRP | | |
| TX_DESC_LRG | CHAR(40) | Description of the | | |
| | | code value, used in list | | |
| | | boxes to present code | | |
| | | for selection and in | | |
| | | reports to describe the | | |
| | | meaning of the code | | |
| | | selected and stored on | | |
| | | the child table | | |

Generally, elements on a list are retrieved using the county as a search key. Each element is provided with a unique identification number, ID_CD, which may be related directly or indirectly (through another table) to the data storage on the data repository 56. The structure of Table 2 is similar to that of Table 1, in that each possible element is listed in the database. This makes it easier for the installer/manager to modify and update the database.

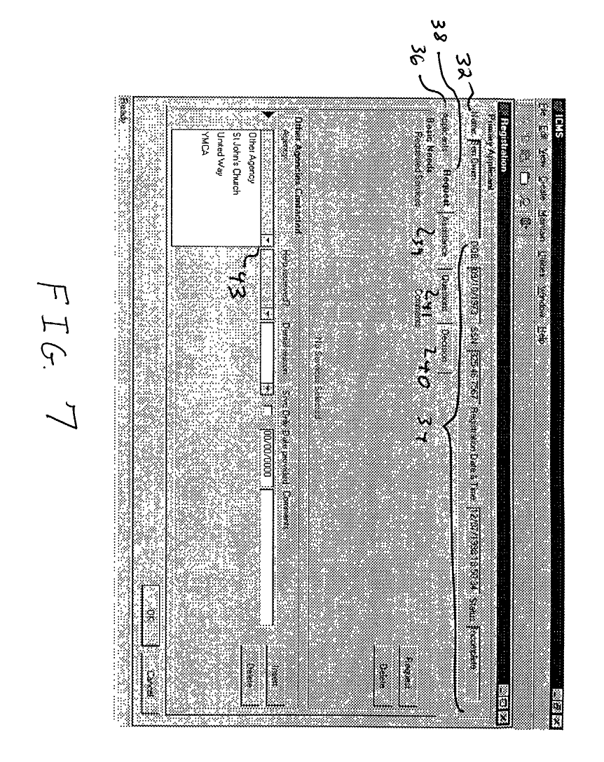

FIG. 6 is a data flow diagram of the dynamic drop-down list creation process. When a Tab Window contains a data element (here referred to as a data column) that uses dynamic lists (such as a drop downs lists) opens, values are retrieved by passing, from the data column S30 to the dynamic code definition table S32 (see table 3), a current location identifier and a group description. The group description ‘groups’ codes and their associated identifiers together. For example: The values ‘Food,’ ‘shelter’ and ‘Job’ would belong to the ‘SERVICES’ group description. A list of elements is returned by the dynamic code definition table S32.

Referring once again to FIG. 4, after the list elements are retrieved, the list is created by sorting the elements, based on the sort order field, in step S1. Next in step S12, the first element is displayed in the usual manner of a pull down list. The procedure returns to step S9 to process any remaining lists. FIG. 7 is an example of a screen produced by the dynamic display system with a pick list 43. The pick list 43 provides options for agencies providing services. Such a list must obviously be tailored to the group involved, if only due to geographical constraints. After all lists are displayed the process goes to step S13.

In step S13, the tab displayed performs its assigned process, be it data collection, data display, or data processing. The actual processing of each of the individual tabs is largely outside the scope of the present invention as such processing is highly dependent upon the actual implementation of the invention.

Once an instruction has been received indicating that the user wishes to select a new tab or exit the program the procedure goes to step S14. In step S14 a determination is made as to whether the processing of the tab requires update to data on the data repositories 56. If such an update is required, it is performed in step S15. In any event the procedure goes to step S16 in which it is determined whether the user has selected a new tab.

If a new tab has been selected, the procedure goes to step S17 and a new display is created around the newly selected tab. Thereafter the procedure repeats from step S7. If no new tab is selected in step S16, the procedure is ended in step S18. Of course this process is repeated for each tab/window the user wishes to utilize. Typically, no new login will be required such the procedure would progress from step S2.

Many modifications are possible to the present invention to enhance its usability in different installations. One of the most useful enhancement is to add fields to each database maintaining a editing history of the entries in the database. This is enormously useful to assist in identifying and processing clients who move from county to county. For example when a client move to a new county, the dynamic display system can track such movement independently of the other systems and provide the case worker with the display associated with the prior counties in which the client resided. This display can be limited to the simple display of information so as to force the case worker to use the appropriate screens for his or her county when entering new information.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A dynamic display system for producing a custom display for each of a plurality of groups in an organization comprising:
a database having a record of each possible display routine for each window for each group and an indication as to whether each display routine is a selected display routine for each group; and
a display procedure that identifies a group of a user, dynamically accesses the records for the identified group, displays an indication of each selected display routine for the group of the user, and creates a display region in which one of the selected display routines is executed.

2. The dynamic display system, as set forth in claim 1, wherein the display procedure creates a tab for each selected display routine and creates the display of one of the selected display in a tab page.

3. The dynamic display system, as set forth in claim 1, wherein the database has the following fields:
a group indication field identifying a group of users;
a display routine field identifying a display routine; and
an selected field indicating whether the display routine is a selected display routine.

4. The dynamic display system, as set forth in claim 3, wherein the database further has a type field for grouping each possible display routine by type and wherein the database has a rule allowing only one display routine of each type to be active.

5. A dynamic display system for displaying dynamic lists wherein elements on a list vary based upon a group in an organization, the system comprising:
a centralized database storing, for each dynamic list utilized by each group, all possible elements in the list and an indication for each element of whether the element is an active element; and
wherein the display procedure provides a service to a display routine of retrieving all of the active elements of a displayed pick list.

6. A method of dynamically displaying an individualized screen based on a group in an organization to which a user belongs, the method comprising:
storing, in a database, for each group an indication of all of the possible display routines along with an indication of whether each possible display routine is an active display routine for that group;
identifying a group to which a user belongs;
accessing the database to retrieve an indication of each active display routine for the group to which the user belongs;
displaying an indication of each active display routine;
creating a sub-section for a selected one active display routine; and
running the selected active display routine and outputting the display of the selected active display routine in the sub-section.

7. A method, as set forth in claim 6, wherein the step of displaying an indication of each active display routines comprises displaying a tab for each active display routine.

8. A method, as set forth in claim 7, wherein step of creating a sub-section comprises forming a tab page in relation to the tab of the display procedure being displayed.

9. A method, as set forth in claim 6, further comprising:
storing, in a list database, for each pick list in each display routine for each group an indication of all possible elements in the pick list along with an indication as to whether the element is an active element; and
displaying each pick list for the display routines in a sub-section by retrieving the active elements from the list database.

10. A dynamic display system for a state-wide human services organization that produces a custom display for each county in the state, the system comprising:
a database having a record of each possible display routine for each window for each county and an indication as to whether each display routine is an active display routine for each county; and
a display procedure that identifies a county of a user, dynamically accesses the records for the identified county, displays an indication of each active display routine, and creates a display in which a selected one of the possible display routines is executed.

11. The dynamic display system, as set forth in claim 10, wherein each display routine accesses an external pre-existing data repository to display information about of client of the human services organization.

12. The dynamic display system, as set forth in claim 10, further comprising:
an install/maintenance procedure that present a user with a table for selecting which display routines are active, the responses of the user being used to create the database.

13. The dynamic display system, as set forth in claim 10, wherein the database has the following fields:
a county indication field;
a display routine indication field; and
an active field indicating whether the display routine is an active display routine.

14. The dynamic display system, as set forth in claim 13, wherein the database further has a type field for grouping each possible display routine by type and wherein the database has a rule allowing only one display routine of each type to be active.

15. The dynamic display system, as set forth in claim 10, further comprising:
a list database storing, for each pick list utilized by each display routine, all possible elements in the list and an indication for each element of whether the element is an active element; and
wherein the display procedure provides a service to a display routine of retrieving all of the active elements of a displayed pick list.

16. A computer readable medium encoded with software for dynamically displaying an individualized screen based on a group in an organization to which a user belongs by performing the procedures of:
storing, in a database, for each group in an organization an indication of all of possible display routines along with an indication of whether each possible display routine is active for that group;
identifying a group to which a user belongs;
accessing the database to retrieve an indication of each active display routine for the group to which the user belongs;
displaying an indication of each active display routine;
creating a sub-section for a selected active display routine; and
running the selected active display routine and outputting the display of the selected active display routine in the sub-section.
